(19) United States
(12) Patent Application Publication
(10) Pub. No.: US 2009/0241801 A1
(43) Pub. Date: Oct. 1, 2009

(54) METHOD AND APPARATUS FOR PRODUCING FINE PARTICLES

(75) Inventors: Kazunori Takahashi, Ashigarakami-gun (JP); Yoshiyuki Miyoshi, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/414,225

(22) Filed: Mar. 30, 2009

(30) Foreign Application Priority Data
Mar. 31, 2008 (JP) 2008-090492

(51) Int. Cl. C04B 16/00; B01F 15/02

(52) U.S. Cl. 106/400; 366/181.6

(57) ABSTRACT

A method for producing fine particles by allowing a dissolved solution prepared by dissolving a material for forming the fine particles into a solvent with the use of a dissolution auxiliary agent and a poor solvent for varying a solubility of the material for the fine particles to mix each other, wherein the fine particles are generated by flowing the dissolved solution, the poor solvent and a dispersing agent solution for dispersing the fine particle through respectively independent supply channels to join each other at one joining channel and flow together. A decomposition and deterioration caused by a reaction between the dispersing agent and a component of the solution is suppressed and fine particles with high monodispersing property can be produced.

### BACKGROUND OF THE INVENTION

1. Field of the Invention

The present invention relates to a method and apparatus for producing fine particles. More particularly, the present invention relates to a buildup process for producing organic pigment fine particles by mixing a dissolved solution prepared by dissolving an organic pigment into a good solvent and a poor solvent whose solubility with respect to the organic pigment is low.

2. Description of the Related Art

Pigments generally exhibit vivid color tone and high coloring power, and they were widely used in many field. Examples of use applications in which pigments are used include paints, printing inks, electrophotographic toners, ink-jet inks, and color filters.

Among those, pigments are favorably suitable as a coloring material for ink-jet inks due to their high water resistivity and high color fastness to light. For example, Japanese Patent Application Publication No. 2004-43776 discloses the buildup process for producing organic pigment fine particles by preparing a pigment solution dissolving organic pigments and a dispersing agent in aprotonic organic solvent under the presence of alkali, and by mixing the pigment solution and water. Usually, in order to stably disperse the precipitated organic pigment fine particles, the dispersing agent is contained into the pigment solution. The mixing of the pigment solution and water can be carried out not only by means of an ultrasonic vibrator or various agitators, but also among the continuously flowing water.

The dispersion liquid of the organic pigment fine particles obtained in the above-mentioned manner is used as ink-jet inks after adjusting the concentration of the coloring material. In another case, after aggregating and separating the organic pigment fine particles by making the dispersion liquid to contact with acid, floats are removed by re-dispersing the organic pigment fine particles into alkaline solution.

### SUMMARY OF THE INVENTION

By the way, as disclosed in Japanese Patent Application Publication No. 2004-43776, a dispersing agent is usually added in order to disperse the fine particles into the pigment solution. However, there was the problem that the dispersing agent is easily decomposed by an acidic or alkaline agent which dissolves the organic pigment. When decomposition and deterioration of such a dispersing agent occur, the generated organic pigment fine particles aggregate each other, and there was an anxiety of failing to stably disperse them.

The present invention has been made in view of the above situation and aims to provide a method and an apparatus for producing fine particles with high monodispersing property while suppressing decomposition and deterioration of the dispersing agent caused by the reaction between the dispersing agent and a component of an ingredient solution.

To achieve the above object, a first aspect of the present invention provides a method for producing fine particles including: supplying a dissolved solution prepared by dissolving a material for forming the fine particles into a solvent with the use of a dissolution auxiliary agent, another solution for varying a solubility of the material for the fine particles and a dispersing agent solution for dispersing the fine particles through independent supply channels, respectively; letting the dissolved solution, the another solution and the dispersing agent solution join and flow together at one joining region; and allowing the dissolved solution, the another solution and the dispersing agent solution to mix each other to generate the fine particles.

In accordance with the first aspect of the present invention, the dispersing agent solution for dispersing the fine particles is allowed to join at one joining region through a supply channel independent from those for the good solvent and the poor solvent. Accordingly, even though the dispersing agent is not mixed with the good solvent or the poor solvent beforehand, the good solvent, the poor solvent and the dispersing agent solution can be instantaneously mixed together at one joining region. Therefore, the dispersing agent can be prohibited from being decomposed by a dissolution auxiliary agent contained in the good solvent.

According to a second aspect of the present invention, in the method for producing fine particles according to the first aspect of the invention, the dispersing agent has reactivity with the dissolution auxiliary agent.

In the method according to the second aspect, the dispersing agent can be prohibited from being decomposed by the dissolution auxiliary agent because it is not necessary for the dispersing agent to be mixed with the dissolution auxiliary agent beforehand. Accordingly, the dispersing agent can stably disperse the generated fine particles without impairing its function as the dispersing agent.

According to a third aspect of the present invention, in the method for producing fine particles according to the first or the second aspect of the invention, the dissolution auxiliary agent is an acidic or an alkaline agent.

Many acidic or alkaline agents as the dissolution auxiliary agent have high reactivity with materials for forming the fine particles. In the method according to the third aspect, even in this case, while prohibiting the decomposition and deterioration of the material for forming the fine particles in minimum, the material for forming the fine particles can be dissolved into a solvent.

According to a fourth aspect of the present invention, in the method for producing fine particles according to any one of the first to third aspects of the invention, the material for forming the fine particle is an organic pigment.

In the method according to the fourth aspect, the organic pigment fine particles can be generated by mixing a poor solvent and a solution prepared by dissolving the organic pigment sufficiently into a good solvent with the assistance of a dissolution auxiliary agent. Further, because the dispersing agent is mixed separately from the good solvent and the poor solvent, an aggregation between the generated organic pigment fine particles can be suppressed and the organic pigment fine particles with high monodispersing property can be obtained.

According to a fifth aspect of the present invention, in the method for producing fine particles according to any one of the first to fourth aspects of the invention, the dispersing agent solution is fed from between the solution and the another solution toward the one joining region.

Thus, a formation of the flow of the dispersing agent solution between the good solvent and the poor solvent enables to stably and instantaneously disperse the fine particles that are precipitated.

To achieve the above object, a sixth aspect of the present invention provides an apparatus for producing fine particles including: a supply channel for independently supplying a dissolved solution which contains a material for forming fine particles and a dissolution auxiliary agent for dissolving the material for forming the fine particles; a supply channel for independently supplying another solution for varying a solubility of the material for forming the fine particles; a supply channel for independently supplying a dispersing agent solution for dispersing the generated fine particles; and one joining region which communicates with the supply channels and allows the dissolved solution, the another solution and the dispersing agent solution to join and flow together.

In accordance with the sixth aspect of the invention, solutions such as a good solvent containing a dissolution auxiliary agent for dissolving the material for forming the fine particles, a poor solvent having a relatively low solubility with the material for forming the fine particles, and a solution of a dispersing agent, are independently supplied respectively. This enables both the dissolution auxiliary agent and the dispersing agent not to contact each other until the time when the solutions join. Further, because the good solvent, the poor solvent and the dispersing agent solution can be allowed to join at one joining region each other in an instant, a direct decomposition of the dispersing agent by the dissolution auxiliary agent in the good solvent can be suppressed.

According to a seventh aspect of the present invention, in the apparatus for producing fine particles according to the sixth aspect of the invention, each of the supply channels includes a branch portion branching into a plurality of channels.

In the apparatus according to the seventh aspect of the invention, the good solvent, the poor solvent, and the dispersing agent solution are allowed to branch into a plurality of flows, respectively, and then, are allowed to join each other and flow together. This enables to increase contact areas between each solution and to efficiently generate and disperse the fine particles.

According to an eighth aspect of the present invention, in the apparatus for producing fine particles according to the sixth or seventh aspect of the invention, the supply channel for supplying the dispersing agent solution is disposed between the supply channel for supplying the good solvent and the supply channel for supplying the poor solvent.

In the apparatus according to the eighth aspect of the invention, since the flow of the dispersing agent solution can be formed between the good solvent and the poor solvent, the precipitated fine particles and the dispersing agent can be mixed rapidly. This enables to restrain the precipitated fine particles from aggregating and to maintain them in a state of being dispersed stably.

In accordance with any one of the aspects of the present invention, a decomposition and deterioration of the dispersing agent caused by a reaction between the dispersing agent and a component of the ingredient solution are suppressed, and fine particles with high monodispersing property can be produced.

### BRIEF DESCRIPTION OF THE DRAWINGS

FIG. 1 is a plan view illustrating the first embodiment of the microdevice in accordance with the present invention;

FIG. 2 is a cross sectional view of the microdevice taken along the line 2-2 of FIG. 1;

FIG. 3 is an enlarged schematic view illustrating the state of a joining member in the microdevice of FIG. 1; and

FIG. 4 is an exploded perspective view illustrating the second embodiment of the microdevice in accordance with the present invention.

### DETAILED DESCRIPTION OF THE PREFERRED EMBODIMENTS

Preferred embodiments of a method and apparatus for producing fine particles in accordance with the present invention will now be described in detail with reference to the accompanying drawings.

In each following embodiment, the explanation will be described about examples of producing organic pigment fine particle using an organic pigment as a material for forming the fine particles. Additionally, the present invention is not limited to this and it goes without saying that the invention can be broadly applied even in the case where the ingredient solution before using for reaction is instable as time lapses.

To begin with, a procedure for producing organic pigment fine particles will be described.

Namely, a slurry solution in which solid matters of the organic pigment are moistened with a good solvent is prepared. In a buildup process of precipitating and generating the fine particles, it is necessary to dissolve the organic pigment completely up to a molecular level. Accordingly, by adding an acidic or alkaline agent into the slurry solution, a dissolved solution L1 made by dissolving the organic pigments into a good solvent is prepared. Then, the dissolved solution L1, the poor solvent L2 that is compatible with the good solvent but does not dissolve the organic pigments, and a dispersing agent solution L3 for dispersing the generated fine particles are allowed to mix each other in an instant and a solubility is varied, thereby precipitating and generating the organic pigment fine particles. Additionally, the acidic or alkaline agent should be selected depending on the kind of the organic pigment to be used.

Next, an explanation about the first embodiment of a microdevice to which the method and apparatus for producing fine particles of the present invention are applied will be described. The embodiment is an example of generating the above-mentioned organic pigment fine particles using a plane type microdevice.

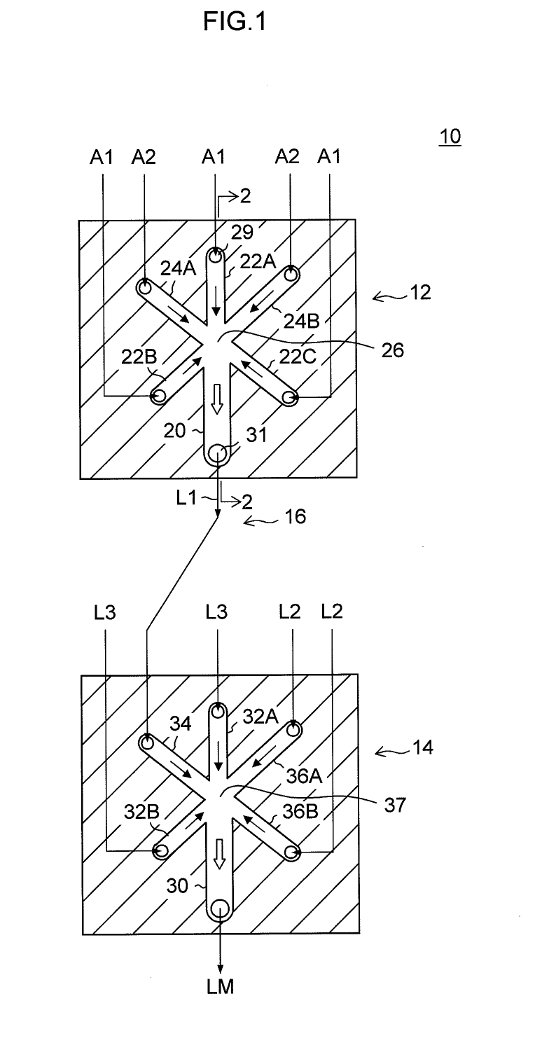

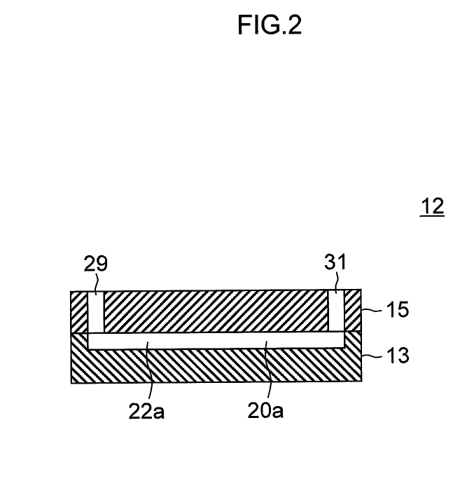

FIG. 1 is a plan view illustrating the first embodiment of the microdevice 10 in accordance with the present invention. FIG. 2 is a cross sectional view of the microdevice taken along the line 2-2 of FIG. 1.

As shown in FIG. 1, the microdevice 10 includes a preparation member 12 for preparing the dissolved solution L1 (ingredient solution), a fine particle formation member 14 for mixing the dissolved solution L1 and the poor solvent L2 to generate fine particles and a connecting tube 16 for feeding the dissolved solution L1 prepared at the preparation member 12 into the fine particle formation member 14.

On the surface of a substrate 13 in the preparation member 12, one mixing groove 20a, five introduction grooves 22a, 22b, 22c, 24a and 24b branching in a radial fashion from the mixing groove 20a are formed. Then, as shown in FIG. 2, one mixing channel 20 and the five introduction channels 22A, 22B, 22C, 24A and 24B branching in a radial fashion from the mixing channel 20 are formed by an integration of a cover plate 15 and the substrate 13 over which the former is covered.

In the cover plate 15, at the position facing to both an outlet side edge portion of the mixing groove 20A and an inlet side edge portion of the introduction groove 22a, through holes 29 and 31 are formed in depthwise direction. The through hole 29 is a hole for introducing an alkaline agent solution A1, and the through hole 31 is a hole for recovering the dissolved solution L1 which was prepared. The other introduction channels and the holes for introducing or recovering the liquid are formed similarly.

The introduction channels 22A, 22B and 22C are the channels for introducing the alkaline agent solution A1 to be used to dissolve the organic pigment into the good solvent, and they are disposed to have equal distance each other in the peripheral direction. The introduction channels 24A and 24B are the channels for introducing the slurry solution A2 prepared by dissolving the organic pigment into the good solvent, and they are disposed to have equal distance each other between the introduction channels 22A and 22B or between the introduction channels 22B and 22C in the peripheral direction. Namely, the first introduction channel 22A is disposed at an opposite side of the mixing channel 20. And, at left and right sandwiching the first introduction channel 22A, the first and second introduction channels 24A and 24B are disposed in a V-shaped manner. Further, at left and right sandwiching the mixing channel 20, the second and third introduction channels 22B and 22 C are disposed in a reverse V-shaped manner.

An inlet portion 26 of the mixing channel 20 communicates with five introduction channels. In the mixing channel 20, the alkaline agent solution Al introduced from the introduction channels 22A, 22 B, 22 C and the slurry solution A2 introduced from the introduction channels 24A and 24B are mixed each other, thereby preparing the dissolved solution L1.

The widths of the introduction channels 22A, 22B and 22 C are not limited in particular, and the equivalent-diameter is, for example, about 1 mm or less. The widths of the introduction channels 24A and 24B are set so that the slurry solution A2 prepared by mixing the organic pigment with the good solvent flows without clogging. For example, the viscosity of the slurry solution A2 is preferably not more than 20 cP, and more preferably not more than 5 cP. When the viscosity is not more than 20 cP, the widths (diameter) of the introduction channels 22A, 22B and 22C are preferably within a range from 0.5 mm to 6 mm, still more preferably within a range from 0.5 mm to 2 mm, and in particular, much more preferably within a range from 1 mm to 2 mm.

The width of the mixing channel 20 may be from 0.5 mm to 6 mm, preferably from 1 mm to 6 mm, and particularly preferably from 2 mm to 6 in equivalent diameter. When the width of the mixing channel 20 is not less than 1 mm in equivalent diameter, it is preferable to set the width of the mixing channel 20 so that the flow is in a transient region or a turbulence region, that is, Reynolds number Re becomes not less than 2,000.

In this context, the equivalent diameter is also called as corresponding diameter, and used in the field of mechanical engineering. When a cylindrical tube equivalent to a pipe having arbitrary sectional shape (which corresponds to a channel in the present invention) is assumed, a diameter of the equivalent cylindrical tube is referred to as an equivalent diameter. The equivalent-diameter (deq) is defined as deq=4A/p wherein A: the cross section of a pipe and p: a length of the wet perimeter (circumferential length) of the pipe. This equivalent diameter, when applied to a cylindrical tube, is equal to a diameter of the cylindrical tube. The equivalent diameter is used for predicting the Theological or heat transfer properties of the pipe on the basis of data about the equivalent cylindrical tube and represents a spatial scale (typical length) of a phenomenon. The equivalent diameter is deq=4 a²/4a=a, for a regular tetragon tube having a side of “a”, and deq=α/\sqrt{3}, for a regular triangle tube having a side of “a”. Alternatively, the equivalent diameter is deq=2h, for a flow between parallel plates having a channel height “h” (see, for example, “Mechanical Engineering Dictionary” ed., The Japan Society of Mechanical Engineers, 1997, Maruzen Co., Ltd.).

A length L of the mixing channel 20 is not particularly limited, however, it is set to a length suitable to sufficiently mix the alkaline agent solution A1 and the slurry solution A2 each other. In addition, in the mixing channel 20, it is preferable that the width of the channel at the inlet portion 26 (the first joining region) relating to the mixing does not exceed 30 mm even at a maximum.

The cross-sectional shape of each channel is not particularly limited to hemicircular in the embodiment. It may be, for example, rectangular, circular, V-shaped, elliptic, trapezoidal and so on.

Each liquid is to be fed into the introduction channel using a solution supply device (liquid feeding pumps, etc., which are not shown).

The fine particle formation member 14 includes, approximately similar to the preparation member 12, one mixing channel 30 and five introduction channels 32A, 32B, 34, 36A, and 36B (supply channels) branching in a radial fashion from the mixing channel 30.

The introduction channels 32A and 32B are channels for introducing the dispersing agent solution L3. The introduction channel 34 is a channel for introducing the dissolved solution L1. The introduction channels 36A and 36B are channels for introducing the poor solvent L2.

The inlet portion 37 (joining region) of the mixing channel 30 communicates with the five introduction channels, and generates the organic pigment fine particles by allowing the dispersing agent solution L3 being introduced from the introduction channels 32A and 32B, the dispersion liquid L1 being introduced from the introduction channel 34 and the poor solvent L2 being introduced from the introduction channels 36A and 36B to mix each other.

The width of the mixing channel 30 may be the same as that of the mixing channel 20. Further, it is preferable that the five introduction channels 32A, 32B, 34, 36A and 36B are formed so that a total sum of their widths becomes larger than the width of the mixing channel 30. As a result, five flows which flow through the five introduction channel 32A, 32B, 34, 36A and 36B, and then join at the inlet portion 37 of the mixing channel 30, will be contracted with each other to form a tapered flow. Then, while forming the multilayer flow L in which thin layers of the dissolved solution L1, the poor solvent L2 and the dispersing agent solution L3 are laminated, they are mixed each other to generate the organic pigment fine particles.

The length of the mixing channel 30 is set, similar to that of the mixing channel 20, to be a sufficient length for generating the organic pigment fine particles.

The connecting tube 16 communicates between the mixing channel 20 of the preparation member 12 and the introduction channels 34A and 34B of the fine particle formation member 14, and it is, for example, a silicon tube, metal tube and so on. Additionally, when the preparation member 12 and the fine particle formation member 14 are formed on the same substrate, a channel communicating between the mixing channel 20 of the preparation member 12 and the introduction channels 34A and 34B of the fine particle formation member 14 can be formed.

A diameter of the connecting tube 16 is set depending on the flow rate of the dissolved solution L1 generated in the preparation member 12. Additionally, a flow rate control pump may be disposed on the way of the connecting tube 16 so that the flow rate of the dissolved solution L1 can be controlled.

The main body of the microdevice 10 can be fabricated by high-precision processing technology such as micro drill machining, micro electro-discharge machining, molding using plating, injection molding, dry etching, wet etching, hot embossing and so on.

Materials for the microdevice 10 are not specifically restricted. Any materials which have corrosion resistance against various solutions to be used, and to which the above processing techniques are applicable may be suitable. Specific examples of the materials to be preferably used include metallic materials (iron, aluminum, stainless steel, titanium, various kinds of metals, etc.), resin materials (acryl resin, PDMS, etc.), glass (silicon, Pyrex (trademark), quartz glass, etc.), parylene (paraxylene vapor deposition) processed glass (silicon, Pyrex (trademark), quartz glass, etc.) quartz glass and Pyrex glass, and fluorine-based or hydrocarbon-based silane coupling processed quartz glass and Pyrex glass.

It is preferable to dispose a heating device (not shown) for heating the microdevice 10 as occasion demands. The heating device may be realized by integrating a heater construction such as a metal resistance wire or Polysilicon into the main body of the microdevice 10. In the case of the heater construction such as the metal resistance wire or Polysilicon, the temperature is controlled by using it in heating, and by urging a thermal cycling in natural cooling in cooling. Regarding a sensing of the temperature in this case, when the metal resistance wire is used as the heater construction, a generally adopted method is integrating another same resistance wire into the main body of the microdevice, and detecting the temperature based on a change in the ohmic value. When Polysilicon is used as the heater construction, a generally adopted method is detecting the temperature with the use of thermoelectric couple. Further, integrating a temperature control function with the use of Peltier element into the main body of the microdevice is adequate.

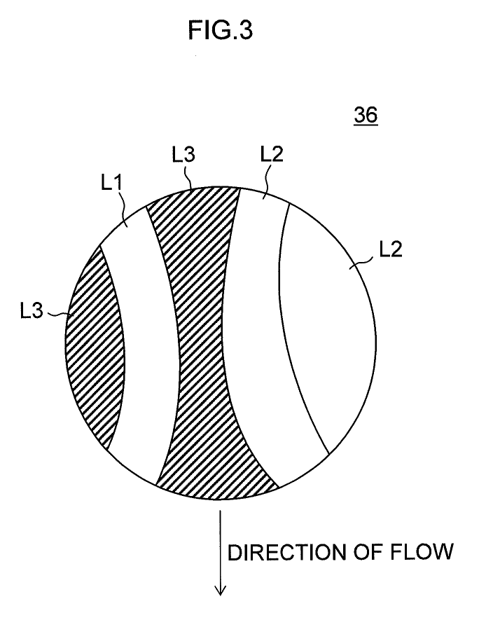

Next, an operation of the microdevice 10 will be described with reference to FIG. 1 and FIG. 3. FIG. 3 is a schematic view illustrating the flow of each liquid at the inlet portion 37 of the mixing channel 30.

The organic pigment and the good solvent are allowed to mix each other beforehand in an agitation tank (not shown) to prepare a slurry solution A2. The viscosity of the slurry solution A2 is about 20 cp.

Subsequently, in the preparation member 12, the alkaline agent solution A1 and the slurry solution A2 are allowed to join each other at an inlet portion 26 of the mixing channel 20 through each introduction channel, so as to mix them each other. Accordingly, the dissolved solution L1 in which the organic pigments are dissolved into a good solvent with the aid of the alkaline agent can be prepared. Additionally, the flow of the dissolved solution L1 in the mixing channel 20 may be either a laminar flow or a turbulent flow.

The dissolved solution L1 thus prepared is continuously fed into the introduction channel 34 of the fine particle formation member 14 through the connecting tube 16. On the other hand, the poor solvent L2 is fed from the introduction channels 36A and 36B by a supply device (not shown), and the dispersing agent solution L3 is fed from the introduction channels 32A and 32B. Then, at the inlet portion (joining portion) 37 of the mixing channel 30, the dissolved solution L1, the poor solvent L2 and the dispersing agent solution L3 are allowed to join each other. At this time, as shown in FIG. 3, a multilayer flow L in which thin layers of the dispersing agent solution L3, the dissolved solution L1, the dispersing agent solution L3, and the poor solvent L2 are laminated from the left side is formed. The multilayer flow allows the dissolved solution L1, the poor solvent L2 and the dispersing agent solution L3 to mix each other with high efficiency in a short time, and to precipitate and generate the organic pigment fine particles.

As thus described, the dissolved solution L1 and the poor solvent L2 are instantaneously made to mix each other via the dispersing agent solution L3, in the fine particle formation member 14. Accordingly, the fine particles precipitated by mixing the solution L1 and the poor solvent L2 can be prevented from aggregation by instantly mixing the fine particles and the dispersing agent.

In addition, because the dispersing agent solution L3 is fed separately from the dissolved solution L1 and the poor solvent L2, they can be mixed each other without any concern about water-solubility and insolubility of the dispersing agent. Therefore, even when a water-insoluble dispersing agent is used, since it is not necessary to dissolve the dispersing agent into the dissolved solution L1, the dispersing agent can be prohibited from being decomposed by the dissolving agent.

Additionally, it is preferable that the total flow rate of the multilayer flow L (the dissolved solution L1+ the poor solvent L2) fed to the inlet portion 37 of the mixing channel 30 is set so that the staying time from the time when the dissolved solution L1 and the poor solvent L2 join at the inlet portion 37 of the mixing channel 30 until the time when they leave from the mixing channel 30 is not longer than 10 msec. For the purpose of adjusting the total flow rate of the multilayer flow L, it is adequate to control a supply device for the above various solutions.

In the present embodiment, an example in which five introduction channels are formed respectively in preparation member 12 and the fine particle formation member 14 is described, however, the present invention is not limited to this example. An arbitrary number (more than one) of introduction channels can be formed for each solution respectively. Further, the arrangement manner of the introduction channels can adopt various kinds of manner also without limiting to FIG. 1. For example, in FIG. 1, two from the left side among the five introduction channels may be determined as the introduction channel for the dissolved solution L1, one central introduction channel may be determined as the introduction channel for the dispersing agent solution L3, and two from the right side may be determined as the introduction channel for the poor solvent L2.

In addition, at the preparation member 12 and the fine particle formation member 14, the width of the channel around the joining member of each introduction channel may be made smaller. The small width enables to increase the line velocity when each liquid joins and collides each other, and enables to enhance the mixing property still more.

Additionally, in the preparation member 12 and the fine particle formation member 14, an example in which the introduction channels are disposed in a manner that different kinds of solution are arranged alternately neighboring each other is illustrated, however, the present invention is not limited hereto, and the introduction channels can be arbitrarily disposed without being limited thereto.

Next, an explanation about the microdevice 40 according to a second embodiment will be attempted.

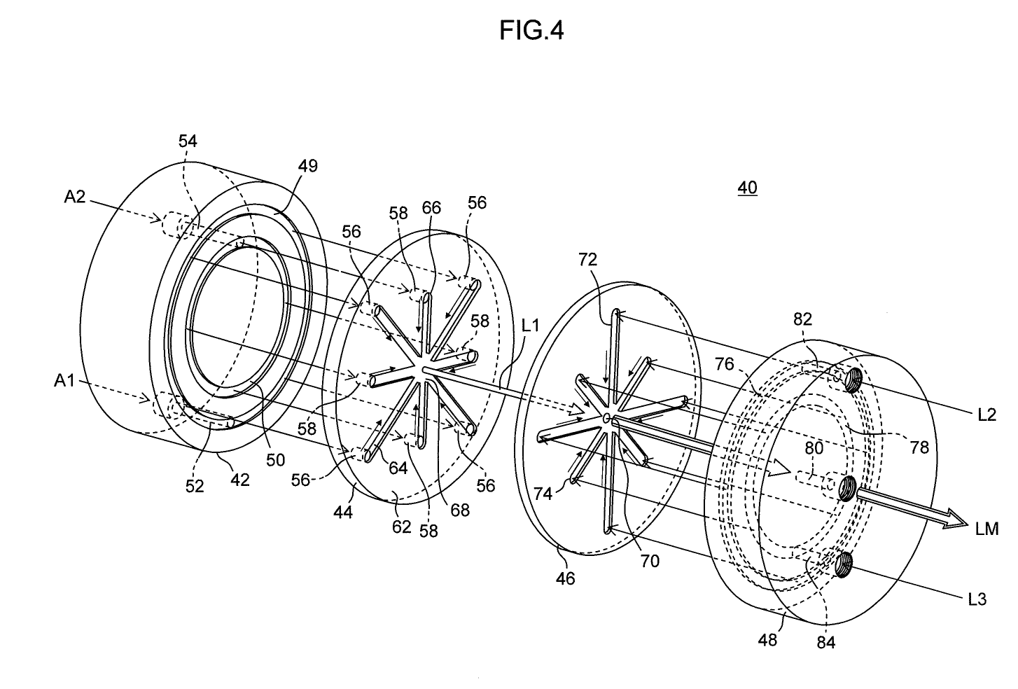

FIG. 4 is an exploded perspective view showing one example of the microdevice 40 according to the present embodiment.

As shown in FIG. 4, the microdevice 40 includes supply element 42, a joining element 44, a mixing element 46 and a discharging element 48, each of which has a cylindrical shape. When the microdevice 40 is composed, these elements are assembled so that these elements are integrally fastened to form a cylindrical shape. To assemble the microdevice 40, for example, through holes (not shown) can be provided in the periphery of each element with equal distance, and the elements can be integrally fastened using bolts, nuts, or the like.

On the surface of the supply element 42 facing to the joining element 44, ring-shaped channels 49 and 50 having rectangular cross sections are formed concentrically. In the illustrated embodiment, through holes 52 and 54 penetrating through the supply element 42 in its thickness (or, height) direction to reach ring-shaped channels 49 and 50 are formed, respectively.

Through holes 56 that penetrate the joining element 44 through its thickness direction are formed. When the elements for composing the microdevice are fastened, an end portion of each through hole 56 located at the surface of the joining element 44 facing to the supply element 42 opens to the ring-shaped channel 49. In the illustrated embodiment, four through holes 56 are formed and they are disposed with equal distance each other in the peripheral direction of the ring-shaped channel 49.

Through holes 58 that penetrate the joining element 44 through its thickness direction are also formed in a similar manner as the through holes 56. Similar to the through holes 56, an end portion of each through hole 58 is formed so as to open to the ring-shaped channel 50. In the illustrated embodiment, through holes 58 are also disposed with equal distance each other in the peripheral direction of the ring-shaped channel 50, and arranged in a manner that the through hole 56 and the through hole 58 locate alternately each other.

On a surface 62 of the joining element 44 facing to the mixing element 46, microchannels 64 and 66 are formed. One ends of the microchannels 64 and 66 are opening portions of the through holes 56 and 58, the other ends are the center 68 of the surface 62. All microchannels extend from the through holes toward the center 68 and join at the center each other. A cross sectional shape of the microchannel may be, for example, rectangular.

A through hole 70 that penetrates the joining element 46 through its thickness direction is formed at the center of the joining element 46. Further, on a surface of the mixing element 46 facing to the discharging element 48, radial branching channels 72 and 74 each of which branches into 4 in a radial fashion from the hole 70 at the center, are formed respectively. End portions of the branching channel 72 communicate with a ring-shaped channel 76 disposed on a surface of the discharging element 48 facing to the mixing element 46. End portions of the branching channel 74 communicate with an ring-shaped channel 78 disposed on a surface of the discharging element 48 facing to the mixing element 46.

On the discharging element 48, through holes 80, 82 and 84 are formed. The through hole 80 passes through the center of the discharging element 48 and penetrates in its thickness direction. The through hole 82 communicates with the ring-shaped channel 76 formed on the surface facing to the mixing element 46 and feeds the poor solvent L2. The through hole 84 communicates with the ring-shaped channel 78 and feeds the dispersing agent solution L3. The through hole 80 opens to the through hole 70 which exists at the center of the mixing element 46 on one end, and opens to an external portion of the microdevice on the other end.

In the present embodiment, the through hole 70 formed on the mixing element 46 has a function of mixing the alkaline agent solution A1 and the slurry solution A2, and then feeding the resultant solution as the dissolved solution L1. Similarly, the through hole 80 formed on the discharging element 48 has a function of mixing the dissolved solution L1 and the poor solvent L2 to generate fine particles, and then feeding the resultant solution as the fine particle dispersion liquid LM.

In the same manner as the first embodiment, the diameter of each through holes 70 and 80 may be, in equivalent diameter, from 0.5 mm to 6 mm, preferably from 1 mm to 6 mm, and particularly preferably from 2 mm to 6 mm. Regarding the length of each through holes 70 and 80, it is appropriate to set so as to be long sufficient to mix the liquids. The lengths of through holes 70 and 80 can be adjusted by changing the thicknesses of the mixing element 46 and the discharging element 48, respectively.

By adopting the above architecture, the alkaline agent solution A1 and the slurry solution A2 fed from the outside of the microdevice at the end portions of the through holes 52 and 54, flow into the ring-shaped channels 49 and 50 via the through holes 52 and 54.

The alkaline agent solution A1 flowing into the ring-shaped channel 49 enters into the microchannel 64 via the through holes 56 communicating with the channel. Further, the ring-shaped channel 50 and the through hole 58 communicate with each other, and the slurry solution A2 flowing into the ring-shaped channel 50 enters into the microchannel 66 via the through holes 58 communicating with the channel. Then, the alkaline agent solution A1 and the slurry solution A2 are divided into four at the joining region, each of which flows into the microchannels 64 and 66 respectively, and then flows toward the center 68.

Further, the central axis of the microchannel 64 and the central axis of the microchannel 66 intersect each other at the center 68. In this manner, the dissolved solution L1 is prepared from the time when the alkaline agent solution A1 and the slurry solution A2 join at the center 68 until the time when the solutions A1 and A2 arrive at the center 80 of the mixing element 46.

On the other hand, the poor solvent L2 is fed via the through hole 82 of the discharging element 48, and flows the branching channel 72 toward the center 70. The poor solvent L2, from the ring-shaped channel 76, branches to flow into four branching channels 72 each of which has a square cross section with sides of 50 μm. These branching channels 72 advance toward the end portion of the through hole 70 functioning as a mixing channel (in the illustrated embodiment, toward the central portion of the mixing element 46). On the other hand, the dispersing agent solution L3, from the ring-shaped channel 78, branches to flow into four branching channels 74 and further, flow toward the end portion of the through hole 70.

Accordingly, in the process in which the poor solvent L2 and the dispersing agent solution L3 flow in a manner that they encompass the dissolved solution L1 flowing through the discharging channel, the dissolved solution L1, the poor solvent L2 and the dispersing agent solution L3 are allowed to mix each other. By the mixing, the organic pigment fine particles are generated and the dispersion liquid LM of the organic pigment fine particles is discharged from the microdevice. Additionally, because the central portion of the mixing element 46 adjoins the central portion of the joining element 44, the central portion substantially functions as a joining region.

The above system enables to produce the organic pigment fine particles having an average particle diameter of not larger than 100 nm, preferably not larger than 40 nm with a favorable monodispersing property.

As described above, by adopting the method and apparatus for producing the fine particles according to the present invention, the dissolved solution L1 containing a dissolution auxiliary agent and the dispersing agent solution L3 are made to flow through different channels separately and are allowed to join each other at the through hole 70. As thus described, because it is not necessary to mix the dissolved solution L1 and the dispersing agent solution L3 until just before carrying out the fine particle generating reaction, it is possible to prevent the dispersing agent from being decomposed by the dissolution auxiliary agent. Further, generally, because it is not necessary that a water-insoluble dispersing agent is mixed into the dissolved solution L1 beforehand, even the water-insoluble dispersing agent can be used effectively.

Additionally, in the above second embodiment, although the example in which each flow of the liquids is divided into four at the joining element 44 or the mixing element 46 is described, the method can be set arbitrarily without being limited thereto.

Further, in each embodiment, although the example in which the dispersing agent solution is mixed simultaneously with the fine particle formation, it may be mixed with the poor solvent L2 immediately after mixing the dispersing agent solution L3 and the dissolved solution L1.

Next, various materials employed in one exemplary embodiment of the invention will be described.

The organic pigment that can be used is not limited in hue thereof, and it may be a magenta pigment, a yellow pigment or a cyan pigment. Specifically, the organic pigment may be a magenta pigment, a yellow pigment or a cyan pigment including perylene, perinone, quinacridon, quinacridonquinone, anthraquinone, anthanthron, benzimidazolone, condensed disazo, disazo, azo, indanthrone, phthalocyanine, triaryl carbonium, dioxanzine, aminoanthraquinone, diketopyrrolopyrrole, thioindigo, isoindoline, isoindolinone, pyranthrone or isoviolanthrone series pigment, or a mixture thereof. Further detailed examples include perylene series pigments such as C. I. Pigment Red 190 (C. I. No. 71140), C. I. Pigment Red 224 (C. I. No. 71127), C. I. Pigment Violet 29 (C. I. No. 71129); perynone series pigments such as C. I. Pigment Orange 43 (C. I. No. 71105) or C. I. Pigment Red 194 (C. I. No. 71100); quinacridon series pigments such as C. I. Pigment Violet 19 (C. I. No. 73900), C. I. Pigment Violet 42, C. I. Pigment Red 122 (C. I. No. 73915), C. I. Pigment Red 192, C. I. Pigment Red 202 (C. I. No. 73907), C. I. Pigment Red 207 (C. I. No. 73900, 73906) or C. I. Pigment Red 209 (C. I. No. 73905); quinacrydonquinone series pigments such as C. I. Pigment Red 206 (C. I. No. 73900/73920), C. I. Pigment Orange 48 (C. I. No. 73900/73920) or C. I. Pigment Orange 49 (C. I. No. 73900/73920); anthraquinone series pigments such as C. I. Pigment Yellow 147 (C. I. No. 60645); anthanthron series pigments such as C. I. Pigment Red 168 (C. I. No. 59300); benzimidazolone series pigments such as C. I. Pigment Brown 25 (C. I. No. 12510), C. I. Pigment Violet 32 (C. I. No. 12517), C. I. Pigment Yellow 180 (C. I. No. 21290), C. I. Pigment Yellow 181 (C. I. No. 11777), C. I. Pigment Orange 62 (C. I. No. 11775) or C. I. Pigment Red 185 (C. I. No. 12516); condensed disazo series pigments such as C. I. Pigment Yellow 93 (C. I. No. 20710), C. I. Pigment Yellow 94 (C. I. No. 20038), C. I. Pigment Yellow 95 (C. I. No. 20034), C. I. Pigment Yellow 128 (C. I. No. 20037), C. I. Pigment Yellow 166 (C. I. No. 20035), C. I. Pigment Orange 34 (C. I. No. 21115), C. I. Pigment Orange 13 (C. I. No. 21110), C. I. Pigment Orange 31 (C. I. No. 20050), C. I. Pigment Red 144 (C. I. No. 20735), C. I. Pigment Red 166 (C. I. No. 20730), C. I. Pigment Red 220 (C. I. No. 20055), C. I. Pigment Red 221 (C. I. No. 20065), C. I. Pigment Red 242 (C. I. No. 20067), C. I. Pigment Red 248, C. I. Pigment Red 262 or C. I. Pigment Brown 23 (C. I. No. 20060); disazo series pigments such as C. I. Pigment Yellow 13 (C. I. No. 21100), C. I. Pigment Yellow 83 (C. I. No. 21108) or C. I. Pigment Yellow 188 (C. I. No. 21094); azo pigments such as C. I. Pigment Red 187 (C. I. No. 12486), C. I. Pigment Red 170 (C. I. No. 12475), C. I. Pigment Yellow 74 (C. I. No. 11714), C. I. Pigment Red 48 (C. I. No. 15865), C. I. Pigment Red 53 (C. I. No. 15585), C. I. Pigment Orange 64 (C. I. No. 12760) or C. I. Pigment Red 247 (C. I. No. 15915); indanthrene series pigments such as C. I. Pigment Blue 60 (C. I. No. 69800), phthalocyanine series pigments such as C. I. Pigment Green 7 (C. I. No. 74260), C. I. Pigment Green 36 (C. I. No. 74265), Pigment Green 37 (C. I. No. 74255), Pigment Blue 16 (C. I. No. 74100), C. I. Pigment Blue 75 (C. I. No. 74160:2) or 15 (C. I. No. 74160); triaryl carbonium series pigments such as C. I. Pigment Blue 56 (C. I. No. 42800) or C. I. Pigment Blue 61 (C. I. No. 42765:1); dioxanzine gin series pigments such as C. I. Pigment Violet 23 (C. I. No. 51319) or C. I. Pigment Violet 37 (C. I. No. 51345); aminoanthraquinone series pigments such as C. I. Pigment Red 177 (C. I. No. 65300); diketopyrrolopyrrole series pigments such as C. I. Pigment Red 254 (C. I. No. 56110), C. I. Pigment Red 255 (C. I. No. 561050), C. I. Pigment Red 264, C. I. Pigment Red 272 (C. I. No. 561150), C. I. Pigment Orange 71 or C. I. Pigment Orange 73; thioindigo series pigments such as C. I. Pigment Red 88 (C. I. No. 73312); isoindoline series pigments such as C. I. Pigment Yellow 139 (C. I. No. 56298), C. I. Pigment Orange 66 (C. I. No. 48210); isoindolinone series pigments such as C. I. Pigment Yellow 109 (C. I. No. 56284) or C. I. Pigment Orange 61 (C. I. No. 11295); pyranthrone series pigments such as C. I. Pigment Orange 40 (C. I. No. 59700) or C. I. Pigment Red 216 (C. I. No. 59710); or isoviolanthrone series pigments such as C. I. Pigment Violet 31 (C. I. No. 60010).

Preferred pigments are quinacridon series, diketo pyrrolo pyrrole series, disazo condensed series, azo series, phthalocyanine series or dioxadine series pigments.

Following dispersing agents can be used in the preferred embodiment of the present invention.

Examples of the anionic dispersing agent (anionic surfactant) include N-acyl-N-alkyltaurine salts, fatty acid salts, alkyl sulfate ester salts, alkyl benzene sulfonates, alkyl naphthalenesulfonates, dialkyl sulfo succinic acid salts, alkylphosphates ester salts, naphthalenesulfonic acid formalin condensates, polyoxyethylene alkyl sulfate ester salts and so on. Among those, N-acyl-N-alkyltaurine salts are preferable. Those disclosed in Japanese Patent Application Publication No. 3-273067 are preferable as N-acyl-N-alkyl taurine salts. Only a single anionic dispersing agent may be used, or two or more anionic dispersing agents may be used in combination.

Examples of the cationic dispersing agent (cationic surfactant) include quaternary ammonium salts, alkoxylated polyamines, aliphatic amine polyglycol ethers, aliphatic amines, diamine and polyamine derived from aliphatic amine and aliphatic alcohol, imidazoline derived from aliphatic acid and salts of these cationic substance. Only a single a cationic dispersing agent may be used, or two or more cationic dispersing agents may be used in combination.

The amphoteric dispersing agent is a dispersing agent having, in the molecule thereof, an anionic group moiety which the anionic dispersing agent has in the molecule, and a cationic group moiety which the cationic dispersing agent has in the molecule.

Examples of the nonionic dispersing agents (nonionic surfactant) include polyoxyethylenealkylethers, polyoxyethylenealkylaryl ethers, polyoxyethylene fatty acid esters, sorbitan fatty acid esters, polyoxyethylenesorbitan fatty acid esters, polyoxyethylenealkylamines, glycerine fatty acid esters and so on. Among these, polyoxyethylenealkylaryl ethers are preferable. Only a single nonionic dispersing agent may be used, or two or more nonionic dispersing agents may be used in combination.

The organic pigmentary dispersing agent is defined as a dispersing agent derived from an organic pigment as a parent material, and prepared by chemically modifying a structure of the parent material. Examples include sugar-containing organic pigmentary dispersing agents, piperidyl-containing organic pigmentary dispersing agents, naphthalene- or perylene-derivative organic pigmentary dispersing agents, organic pigmentary dispersing agents having a functional group linked through a methylene group to a parent-structure, organic pigmentary dispersing agents (parent-structure) chemically modified with a polymer, organic pigmentary dispersing agents having a sulfonic acid group, organic pigmentary dispersing agents having a sulfonamide group, organic pigmentary dispersing agents having an ether group, and organic pigmentary dispersing agents having a carboxylic acid group, carboxylic acid group or a carboxamide group.

Specific examples of the polymer dispersing agent include polyvinylpyrrolidone, polyvinyl alcohol, polyvinylmethylether, polyethylene oxide, polyethylene glycol, polypropylene glycol, polyacrylamide, vinyl alcohol-vinyl acetate copolymer, polyvinyl alcohol-partly formulated product, polyvinyl alcohol-partly butyralated product, vinylpyrrolidone-vinyl acetate copolymer, polyoxyethylene/propylene oxide block copolymer, polyacrylate, polyvinyl sulfate, poly(4-vinylpyridine) salts, polyamide, polyallylamine salts, condensed naphthalenesulfonates, styrene-acrylate copolymer product, styrene-methacrylate copolymer product, acrylate-acrylate copolymer product, acrylate-methacrylate copolymer product, methacrylate-acrylate copolymer product, methacrylate-methacrylate copolymer product, styrene-itaconic acid salt copolymer product, itaconic acid ester-itaconic acid salt copolymer product, vinylnaphthalene-acrylate copolymer product, vinylnaphthalene-methacrylate copolymer product, vinylnaphthalene-itaconic acid salt copolymer product, cellulosic, carbohydrate derivative and so on. Besides, natural polymers such as alginate, gelatin, albumen, casein, Arabian rubber, Tongant rubber, lignosulfonate can be also usable. Among those, polyvinylpyrrolidone is preferable. Only a single polymer may be used, or two or more polymers may be used in combination. Further, examples of the polymer dispersing agent include an embodiment prepared by allowing an anionic dispersing agent to be contained into an aqueous medium and by allowing a nonionic dispersing agent and/or a polymer dispersing agent to be contained into a solution into which organic pigments are dissolved.

In order to improve a homogeneous dispersion property and a storage stability of the organic pigment still more, a blending amount of the dispersing agent is preferably within a range from 0.1 to 1,000 parts by mass, more preferably within a range from 1 to 500 parts by mass, further preferably within a range from 10 to 250 parts by mass with respect to 100 parts by mass of the organic pigments. When the blending amount is less than 0.1 parts by mass, there may be a case wherein the dispersion stability of the organic pigment fine particles is not improved.

Additionally, in the method for producing the fine particle explained in the preferred embodiment, although the description was made about the example for producing the organic pigment fine particles, the method and apparatus for producing fine particles of the present invention can be applied to various kinds of reaction. Examples of the other materials for forming the fine particles include titanium dioxide, calcium carbonate, copper oxide, aluminum oxide, iron oxide, chromium oxide, bismuth vanadiumoxide, rutile type blending phase pigments, silver halide, silica and carbon black, without being limited to them.

It is necessary that the organic pigment is homogeneously dissolved in an alkaline or acidic aqueous solution. It depends on the nature of the pigment whether the organic pigment in interest may be more easily dissolved homogeneously under either alkaline or acidic, to select the conditions in which the organic pigment be dissolved under alkaline or dissolved under acidic. In general, in the case of the pigment having in the molecule thereof a group dissociative under alkaline, the alkaline medium is used, and in the case of the pigment having no group dissociative under alkaline and having in the molecule thereof many nitrogen atoms to which protons easily adhere, the acidic medium is used. For example, quinacridon-, diketopyrrolopyrrole-, and condensed disazo series pigments are dissolved in the alkaline medium, and a phthalocyanine series pigment is dissolved in the acidic medium.

Examples of a base that can be used in the case that the pigment is dissolved in alkaline medium include inorganic bases such as sodium hydroxide, potassium hydroxide, calcium hydroxide or barium hydroxide; or organic bases such as trialkylamine, diazabicycloundecene (DBU), and metal alkoxide.

The amount of the base to be used is not particularly limited, as long as the base in the amount can make the pigment be dissolved homogeneously. In the case of the inorganic base, the amount thereof is preferably from 1.0 to 30 mole equivalents, and more preferably from 2.0 to 25 mole equivalents, and further preferably from 3 to 20 mole equivalents, with respect to the pigment, respectively. In the case of the organic base, the amount thereof is preferably from 1.0 to 100 mole equivalents, more preferably from 5.0 to 100 mole equivalents, and further preferably from 20 to 100 mole equivalents, with respect to the pigment, respectively.

Examples of an acid to be used in the case that the pigment is dissolved in the acidic medium include inorganic acids such as sulfuric acid, hydrochloric acid or phosphoric acid; or organic acid such as acetic acid, trifluoroacetic acid, oxalic acid, methanesulfonic acid or trifluoromethane sulfonic acid. Among those, sulfuric acid is particularly preferable.

The amount of the acid to be used is not particularly limited, as long as the amount can make the pigment be dissolved homogeneously. In many cases, the acid is used in excessive amount compared to the base. Regardless the kind of the acid being an inorganic acid or an organic acid, the amount the acid to be used is preferably from 3 to 500 mole equivalents, more preferably from 10 to 500 mole equivalents, and further preferably from 30 to 200 mole equivalents, with respect to the pigment, respectively.

The present invention can be broadly applied to the technology for mixing or reacting a plurality of solution and, in particular, preferably applied to a case where an ingredient solution is instable with a time lapse. In addition, although an example of generating fine particles by making the solubility of materials for forming fine particles to vary using a poor solvent and a good solvent in the embodiment, it is not limited thereto. For example, fine particles can be generated by varying pH-value. Also, despite the illustration about a plane type or a lamination type microdevice in the above each embodiment, the type of the microdevice is not limited thereto. Concentric core-shaped multi-cylindrical tube type microdevices to concentrically form a multi-cylindrical laminar flow can be used as an apparatus for preparing an ingredient solution.

What is claimed is:

1. A method for producing fine particles, comprising:
supplying a dissolved solution prepared by dissolving a material for forming the fine particles into a solvent with the use of a dissolution auxiliary agent, another solution for varying a solubility of the material for the fine particles and a dispersing agent solution for dispersing the fine particles through independent supply channels, respectively;
letting the dissolved solution, the another solution and the dispersing agent solution join and flow together at one joining region; and
allowing the dissolved solution, the another solution and the dispersing agent solution to mix each other to generate the fine particles.

2. The method for producing fine particles according to claim 1, wherein the dissolution auxiliary agent is an acidic or an alkaline agent.

3. The method for producing fine particles according to claim 1, wherein the material for forming the fine particles is an organic pigment.

4. The method for producing fine particles according to claim 1, wherein the dispersing agent solution is fed from between the dissolved solution and the another solution toward the one joining region.

5. The method for producing fine particles according to claim 1, wherein the dispersing agent has reactivity with the dissolution auxiliary agent.

6. The method for producing fine particles according to claim 5, wherein the dissolution auxiliary agent is an acidic or an alkaline agent.

7. The method for producing fine particles according to claim 5, wherein the material for forming the fine particles is an organic pigment.

8. The method for producing fine particles according to claim 5, wherein the dispersing agent solution is fed from between the dissolved solution and the another solution toward the one joining region.

9. An apparatus for producing fine particles comprising:
a supply channel for independently supplying a dissolved solution which contains a material for forming fine particles and a dissolution auxiliary agent for dissolving the material for forming the fine particles;
a supply channel for independently supplying another solution for varying a solubility of the material for forming the fine particles;
a supply channel for independently supplying a dispersing agent solution for dispersing the generated fine particles; and
one joining region which communicates with the supply channels and allows the dissolved solution, the another solution and the dispersing agent solution to join and flow together.

10. The apparatus for producing fine particles according to claim 9, wherein the supply channel for supplying the dispersing agent solution is disposed between the supply channel for supplying the dissolved solution and the supply channel for supplying the another solution.

11. The apparatus for producing fine particles according to claim 9, wherein each of the supply channels comprises a branch portion branching into a plurality of channels.

12. The apparatus for producing fine particles according to claim 11, wherein the supply channel for supplying the dispersing agent solution is disposed between the supply channel for supplying the dissolved solution and the supply channel for supplying the another solution.
